(19) United States
(12) Patent Application Publication
(10) Pub. No.: US 2010/0146424 A1
(43) Pub. Date: Jun. 10, 2010

(54) INFORMATION PROCESSING APPARATUS AND METHOD FOR PRESENTING CONTENT OF AN INSTRUCTION AND AN INSTRUCTION LOCUS

(75) Inventors: Yusuke Chihara, Funabashi-shi (JP); Keiichi Yamamoto, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/631,583

(22) Filed: Dec. 4, 2009

(30) Foreign Application Priority Data
Dec. 8, 2008 (JP) 2008-312626

(51) Int. Cl. G06F 3/048

(52) U.S. Cl. 715/768; 715/764; 715/810; 715/854; 715/856

(57) ABSTRACT

An information processing apparatus includes an instruction identification unit that identifies an instruction based on an operation of the instruction of a user, an instruction locus identification unit that identifies an instruction locus corresponding to the instruction identified by the instruction identification unit based on association information that associates the instruction and the instruction locus of the instruction, and a presentation unit that associates and presents content of the instruction identified by the instruction identification unit and the instruction locus identified by the instruction locus identification unit and presents the content of the instruction and the instruction locus to give the instruction, to the user while explicitly illustrating a correspondence relationship of both.

### BACKGROUND OF THE INVENTION

1. Field of the Invention

The present invention relates to an information processing apparatus and method for presenting content of an instruction and an instruction locus to give instructions to a user while explicitly illustrating a correspondence relationship between them both.

2. Description of the Related Art

When a user instructs a device to perform processing, the user can successively select menus having a hierarchical structure. According to this method, even a user unfamiliar with a device use can find away of giving instructions to perform desired processing because icons or menu items illustrate contents of instructions. In this method, however, it is necessary to repeat menu selections until the instruction content desired by the user appears on the menu, making the work complicated for the user.

To solve this problem, some information processing devices provided with a pointing device such as a pen tablet and touch panel allow the user to provide instructions to the device by inputting a locus to the device. Using this function, instructions can be provided to the device immediately by inputting an instruction locus corresponding to the desired instruction content, thereby improving work efficiency as compared with conventional methods.

However, it is necessary for the user to remember the instruction locus corresponding to the desired instruction content so that instructions can be given to the device by locus input. It is difficult to perform the operation, particularly for the user who is unfamiliar with such device use.

As described above, it is necessary for the user to perform complicated operations to give instructions when an instruction method based on non-locus input is used. On the other hand, it is necessary for the user to remember a correspondence relation ship between the desired instruction content and instruction locus in advance when an instruction method based on locus input is used. An example of a conventional technique to solve these problems is discussed in Japanese Patent No. 3704777.

Both instructions methods based on locus input and based on non-locus input can be used by a pen input type information processing apparatus discussed in Japanese Patent No. 3704777. If the instruction method to a device is based on locus input, the instruction content corresponding to the instruction locus is searched for and the instruction is immediately executed. If, on the other hand, the instruction method is based on non-locus input, an instruction locus corresponding to the instruction content is presented to a display apparatus for the user and then, the instruction is executed.

However, in the configuration discussed in Japanese Patent No. 3704777, problems arise in practice. Such problems are discussed further below.

A pen input type information processing apparatus discussed in Japanese Patent No. 3704777 presents a locus corresponding to the instruction content when a single instruction through non-locus input is provided. However, depending on devices to which instructions are given, the user may want to specify a plurality of processes to the device simultaneously. For example, when a document is printed by an ordinary printer, a plurality of items such as the size and orientation of paper, scaling factor, number of copies, and page layout is set.

When an instruction locus corresponding to setting of these items is presented, if a locus is to be presented each time every item is set, such presentation could become an obstacle for the user who wishes to continue print settings in a short time.

### SUMMARY OF THE INVENTION

The present invention is directed to presenting content of an instruction and an instruction locus to give instructions to a user while explicitly illustrating a correspondence relationship of both.

According to an aspect of the present invention, an information processing apparatus includes an instruction identification unit that identifies an instruction based on an operation of the instruction of a user, an instruction locus identification unit that identifies an instruction locus corresponding to the instruction identified by the instruction identification unit based on association information that associates an instruction and the instruction locus of the instruction, and a presentation unit that associates and presents content of the instruction identified by the instruction identification unit and the instruction locus identified by the instruction locus identification unit.

By adopting such a configuration, the content of an instruction and an instruction locus for giving the instruction can be presented to a user while explicitly illustrating a correspondence relationship of both the content and locus.

The present invention is also directed to an information processing method, a program, and a storage medium.

According to the present invention, the content of an instruction and the instruction locus for giving instructions can be presented to a user while explicitly illustrating a correspondence relationship of both.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a hardware configuration of an information processing apparatus.

FIG. 2 is a diagram illustrating an example screen display on a display unit.

FIG. 3 is a diagram illustrating an example screen display when rendering of an instruction locus corresponding to a “4in1” setting is started.

FIG. 4 is a diagram illustrating an example screen display when the instruction locus corresponding to the “4in1” setting is presented.

FIG. 5 is a diagram illustrating an example screen display when presentation of the instruction locus corresponding to the “4in1” setting is completed.

FIG. 6 is a diagram illustrating an example in which the display of instruction content hides an instruction locus being presented.

FIG. 7 is a diagram illustrating an example method of deciding a movement destination of the display of instruction content.

FIG. 8 is a diagram illustrating an example a case when a movement prohibited region of the display of instruction content is set at an edge of the screen.

FIG. 9 is a diagram illustrating details of display information of instruction content stored in a read-only memory (ROM).

FIG. 10 is a diagram illustrating details of locus information stored in a ROM.

FIG. 11 is a diagram illustrating details of instruction/locus correspondence information stored in a ROM.

FIG. 12 is a diagram illustrating details of a reference table for locus presentation held in a random access memory (RAM) by the information processing apparatus.

FIG. 13 is a flow chart illustrating example main processing.

FIG. 14 is a flow chart illustrating details of pre-processing in FIG. 13.

FIG. 15 is a flow chart illustrating details of rendering processing in FIG. 13.

FIG. 16 is a flow chart illustrating details of movement destination calculation processing in FIG. 15.

FIG. 17 is a flow chart illustrating details of movement destination correction processing in FIG. 15.

FIG. 18 is a diagram illustrating an example in which the display of instruction content hides an instruction locus rendered in the past.

FIG. 19 is a diagram illustrating an example in which a locus presentation region is divided into a group of meshes.

FIG. 20 is a diagram illustrating an example mesh to decide a new movement destination of the display of instruction content.

FIG. 21 is a diagram illustrating an example of the new movement destination of the display of instruction content.

FIG. 22 is a diagram illustrating details of mesh information held in a RAM.

FIG. 23 is a flow chart illustrating details of rendering processing in a second exemplary embodiment.

FIG. 24 is a flow chart illustrating details of movement destination correction processing in FIG. 23.

FIG. 25 is a diagram illustrating an example screen display when, like a first exemplary embodiment and the second exemplary embodiment, the instruction locus corresponding to the “4in1” setting is rendered.

FIG. 26 is a diagram illustrating an example screen display when the instruction locus is presented.

FIG. 27 is a diagram illustrating an example screen display when the display of instruction content is brought back to its original position halfway through presentation of the instruction locus.

FIG. 28 is a flow chart illustrating details of rendering processing in a third exemplary embodiment.

FIG. 29 is a diagram illustrating an example in which a rendering color of the instruction locus and a color in the display of instruction content are matched.

FIG. 30 is a diagram illustrating an example in which an outer frame of the corresponding display of instruction content is changed to a thicker display in timing of presenting the instruction locus that makes the “4in1” setting.

### DESCRIPTION OF THE EMBODIMENTS

Various exemplary embodiments, features, and aspects of the invention will be described in detail below with reference to the drawings.

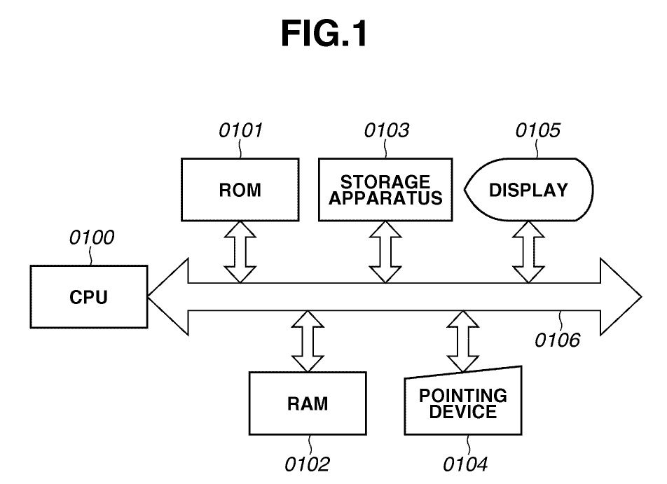

FIG. 1 illustrates the hardware configuration of an information processing apparatus. A central processing unit (CPU) 0100 performs processing based on an information processing program according to an exemplary embodiment and controls a RAM 0102 to temporarily store information necessary to execute the program. A ROM 0101 has programs such as a basic I/O programs and various types of data stored therein. The RAM 0102 functions as a main memory or working area of the CPU 0100. A storage apparatus 0103 stores an information processing program and the like therein. Further, the information processing apparatus has a pointing device 0104. A display 0105 presents the instruction content and instruction loci output by the CPU 0100 based on the information processing program. As an alternative to the pointing device 0104 and the display 0105, a device such as a touch panel display having both functions may be installed. A system bus 0106 controls the flow of data in the information processing apparatus.

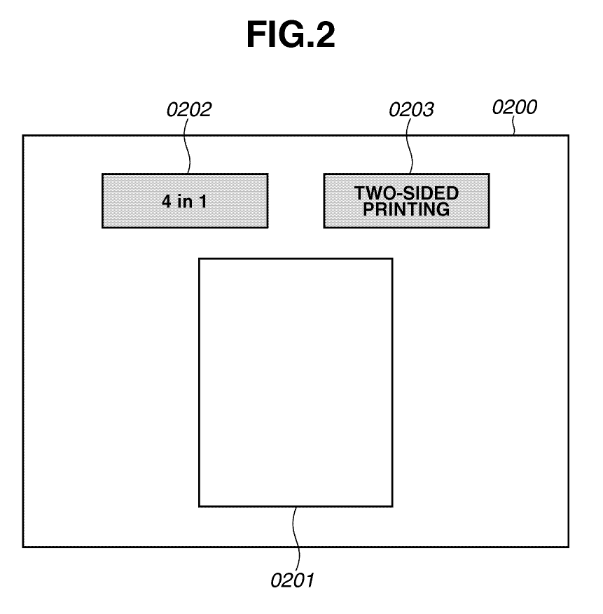

Next, operations of the information processing apparatus configured as described above will be described in detail with reference to FIGS. 2 to 17.

In the present exemplary embodiment, it is assumed that when a document is printed by an ordinary printer, a plurality of instructions to make various settings is given by the user through non-locus input. To give an instruction through non-locus input, for example, a menu displayed on the display 0105 is selected. The information processing apparatus identifies the instruction given through non-locus input by the user based on user operations (instruction identification). After making sure that the user has given all instructions through non-locus input, the information processing apparatus presents various kinds of instruction contents and instruction loci to be input to carry out each instruction more swiftly, to the user while explicitly illustrating a correspondence relationship between both the contents and loci (that is, associating both the contents and loci with each other).

FIG. 2 is a diagram illustrating the screen display displayed on the display 0105. A locus presentation region 0201, and displays 0202 and 0203 of instruction content are presented in a screen 0200. A rectangle representing a print document is displayed in the locus presentation region 0201 and each instruction locus will be rendered near the rectangle. It is assumed in examples of the present exemplary embodiment that the user has provided instructions concerning two items in advance. One item concerns a print layout in which a “4in1” setting is adopted, that arranges four pages on a sheet of printing paper. This setting instruction is presented to the user by the display 0202 of instruction content.

Another setting item, on the other hand, is a “two-sided printing” setting that performs printing on both sides of printing paper. Concerning this setting instruction, its content is also presented to the user by the display 0203 of instruction content. Since the user provides these setting instructions through non-locus input, the information processing apparatus presents instruction loci that enable the user to provide instructions more swiftly to the user. At this point, it is necessary for the information processing apparatus to explicitly illustrate correspondence relationship between a plurality of pieces of instruction content and a plurality of instruction loci.

To explicitly illustrate correspondences between the display of instruction content and instruction loci, the information processing apparatus in the present exemplary embodiment moves the display of the corresponding instruction content to within a fixed distance from a locus in timing with the start of locus rendering. The information processing apparatus moves the display of the instruction content by tracking animation that sequentially renders a locus from the start point and, when rendering of the locus is completed, brings back the display of the instruction content to its original position. In the meantime, the information processing apparatus does not allow the display of instruction content to move that does not correspond to the instruction locus being presented. Thus, the user can clearly grasp the processing (instruction content) to which the presented instruction locus corresponds by checking the display of instruction content that is moving while tracking the animation.

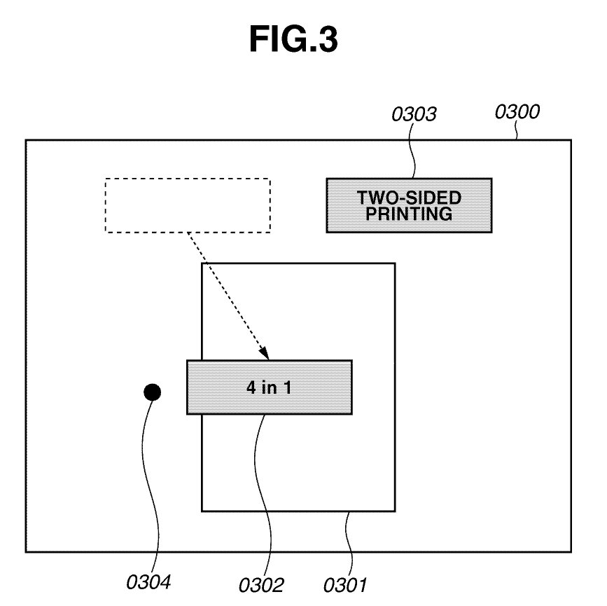

An example will be illustrated below in which an instruction locus for making the “4in1” setting is presented to the user. FIG. 3 is a diagram illustrating the screen display when rendering of the instruction locus corresponding to the “4in1” setting is started. A pointer 0304 in FIG. 3 indicates the position of a point of an instruction locus rendered immediately before and the information processing apparatus moves a display 0302 of the instruction content corresponding to the instruction locus to the vicinity of the pointer 0304 in timing with the start of rendering of the instruction locus.

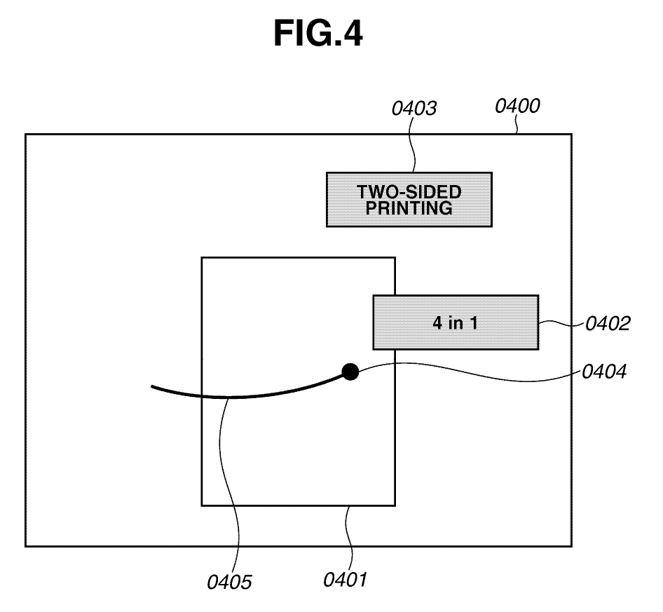

On the other hand, the information processing apparatus does not allow a display 0303 of the instruction content that does not correspond to the instruction locus to be presented now, to move from the predetermined position. Subsequently, as illustrated in FIG. 4, a locus for making the “4in1” setting is sequentially rendered from the start point. At this point, the information processing apparatus displays a display 0402 of the instruction content which moves in the screen by tracking rendered animation of the locus.

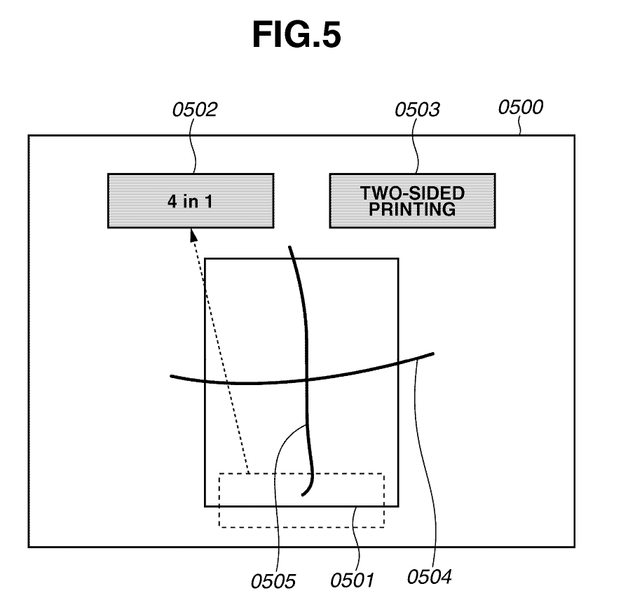

Then, as illustrated in FIG. 5, when rendering of the instruction locus for making the “4in1” setting is completed, the display of the corresponding instruction content ends tracking the animation and the information processing apparatus brings the display to its initial position. When, similar to these operations, a locus concerning “two-sided printing” is subsequently rendered, the information processing apparatus does not move a display 0502 of instruction content from the predetermined position and displays a display 0503 of instruction content in such a way that the display 0503 moves by tracking locus rendering.

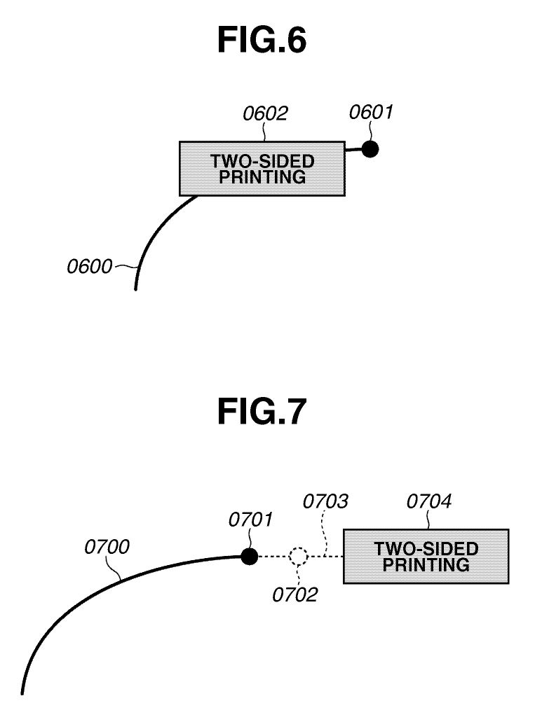

Here, when the display of instruction content moves by tracking the rendering of an instruction locus, as illustrated in FIG. 6, a display 0602 of instruction content can hide an instruction locus 0600 being displayed depending on physical relationships of the display 0602 of instruction content, a locus rendering pointer 0601 and the rendering direction of the locus. In such a case, the display of instruction content could become an obstacle for the user to understand the shape of an instruction locus. To avoid such a problem, the information processing apparatus decides the position to which the display of instruction content is moved in the following manner.

As illustrated in FIG. 7, the information processing apparatus determines a straight line 0703 passing through a pointer 0701 indicating the position of a point of an instruction locus rendered immediately before, and a point 0702 of an instruction locus to be rendered next. Thus, the information processing apparatus presents a display 0704 of instruction content on the straight line 0703. Accordingly, the display of instruction content is always moved in the direction in which the locus will be rendered and thus, a situation in which, as illustrated in FIG. 6, the display of instruction content hides an instruction locus being presented can be avoided. The point 0702 and the straight line 0703 are illustrated for convenience of description and are actually invisible to the user.

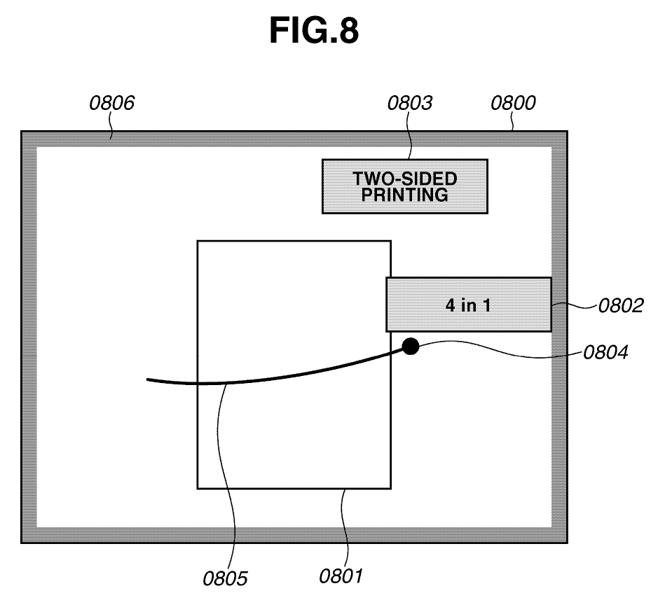

When the pointer approaches a screen edge while the display of instruction content moves in tracking the locus rendering, the tracking display of instruction content may go out of the screen so that the user cannot check the display of instruction content. To avoid such a situation, as illustrated in FIG. 8, the information processing apparatus sets a region 0806 at screen edges in which movement of the display of instruction content is prohibited. If the information processing apparatus determines that, as a result of tracking the rendering of an instruction locus, the display of instruction content enters the prohibited region, the tracking shall be stopped.

Here, the mode of each screen display, setting item content, a number of setting items, and shapes of instruction loci are only examples and are not necessarily be limited to the above description. This also applies to the second exemplary embodiment and the third exemplary embodiment described below and other exemplary embodiments.

An example of processing to realize the operation of the information processing apparatus described here will be described below in detail using flow charts.

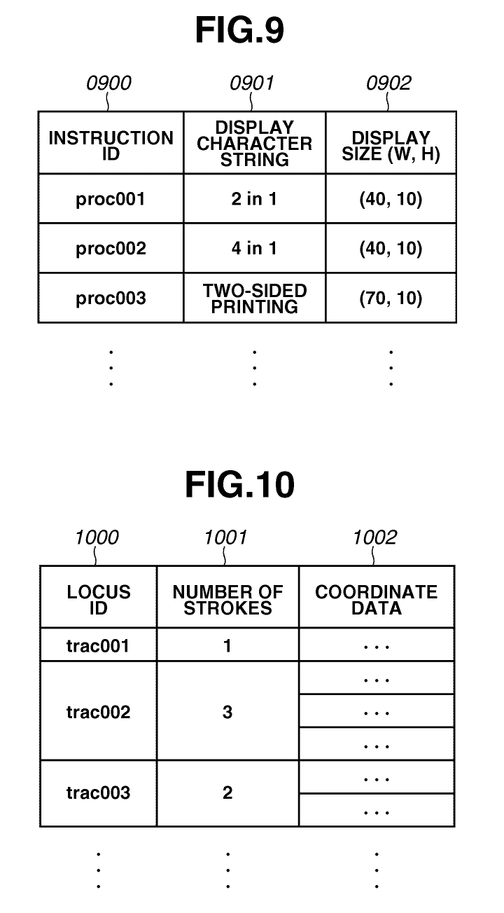

FIG. 9 is a diagram illustrating details of display information of instruction content stored in the ROM 0101. In FIG. 9, an instruction ID 0900 is uniquely assigned to each instruction. The instruction ID 0900 is used when instruction loci corresponding to various kinds of instruction content (various print settings in the present exemplary embodiment) instructed by the user are searched for. Next, in FIG. 9, display character strings 0901 is presented to the user as actual instruction content stored therein. Strings such as “4in1” and “two-sided printing” in the display of instruction content illustrated in FIGS. 2 to 8 are stored in this region. In FIG. 9, display size 0902 has a display size of each piece of instruction content stored therein. This information is used, when the display of instruction content moves to a screen edge, to allow the display to avoid going out of the screen.

FIG. 10 is a diagram illustrating details of locus information stored in the ROM 0101. In FIG. 10, a locus ID 1000 is uniquely assigned to each instruction locus held therein. Similar to the instruction ID 0900, the locus ID 1000 is used when instruction loci corresponding to various kinds of processing instructed by the user are searched for. In FIG. 10, in the number of strokes 1001, a number of strokes is stored for each stored locus. Further, in FIG. 10, in coordinate data 1002, coordinate data of each locus is stored for each stroke. The coordinate data 1002 is normalized in advance so that points are rendered at regular intervals. The above information is used when the shape of an instruction locus is actually presented to the user. The coordinate data 1002 is not limited to discrete coordinate values and may be vector data or of other representation types.

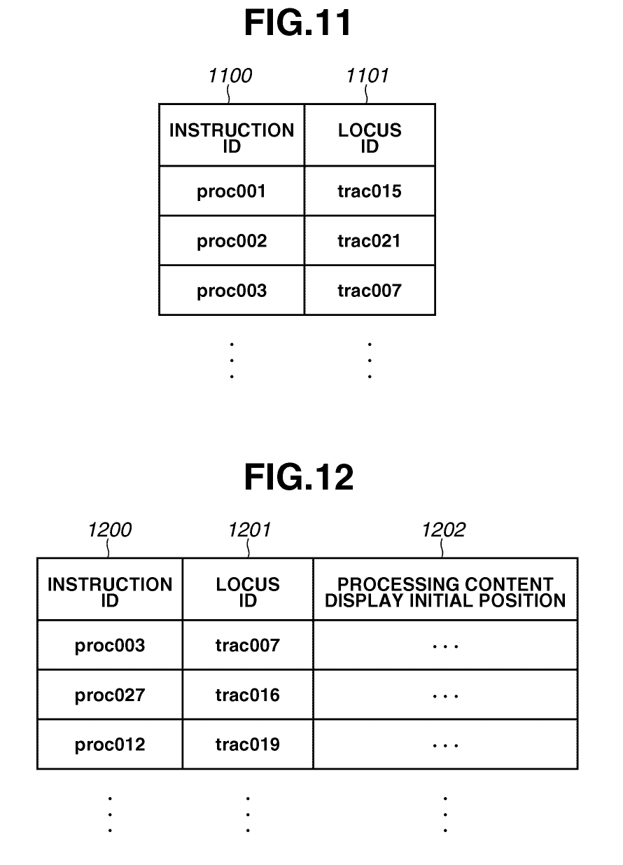

FIG. 11 is a diagram illustrating details of instruction/locus correspondence information stored in the ROM 0101. An instruction ID 1100 and a locus ID 1101 are stored in a table and a correspondence relationship between both IDs is held therein. After the user makes various settings, the information processing apparatus searches the stored information for data of an instruction locus to be rendered. The instruction/locus correspondence information illustrated in FIG. 11 is only an example of association information that associates instructions and loci.

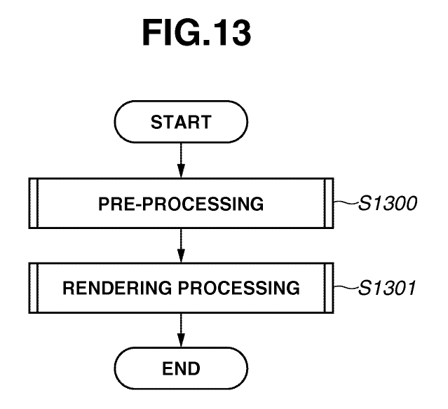

FIG. 12 is a diagram illustrating details of a reference table used in presenting the locus held in the RAM 0102 by the information processing apparatus. An instruction ID 1200 is stored in the order instructed by the user. The information processing apparatus searches for a locus ID 1201 corresponding to a stored instruction ID by referring to the instruction/locus correspondence information illustrated in FIG. 11 (instruction locus identification) and stores the locus ID 1201 in the reference table when presenting the locus. The information processing apparatus also stores the initial position of the display of instruction content to be presented to the user in a processing content display initial position 1202 in FIG. 12. The information processing apparatus uses this information as information to bring the display of instruction content that moves in tracking the locus rendering, back to its initial position in the end. Information in the reference table used in presenting the locus described here is stored in pre-processing (step S1300) in FIG. 13 described later.

FIG. 13 is a flow chart illustrating main processing. In this example, it is assumed that the information processing apparatus performs pre-processing in advance in step S1300 and then performs rendering processing for the display of an instruction locus and instruction content in step S1301.

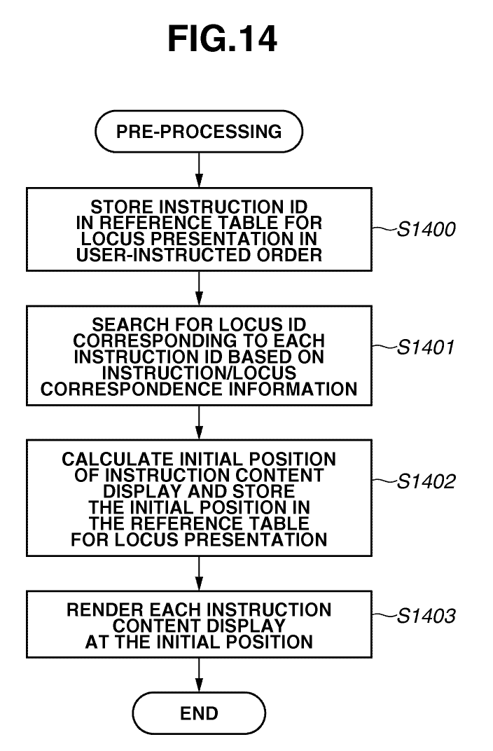

FIG. 14 is a flow chart illustrating details of pre-processing (step S1300) in FIG. 13. In step S1300, mainly, the data in the reference table used in locus presentation illustrated in FIG. 12 is stored. First, in step S1400, the information processing apparatus stores the instruction ID in the reference table for locus presentation in the order instructed by the user. The information processing apparatus obtains each instruction ID by accessing the ROM 0101 and referring to the display information of instruction content illustrated in FIG. 9.

Subsequently, in step S1401, the information processing apparatus searches for the locus ID corresponding to each stored instruction ID and stores the locus ID in the reference table for locus presentation in the same manner. The information processing apparatus obtains the correspondence relationship between the instruction ID and locus ID by referring to the instruction/locus correspondence information illustrated in FIG. 11 (instruction locus identification). Subsequently, in step S1402, the information processing apparatus calculates coordinates of the initial position of the display of each piece of instruction content and stores the coordinates in the reference table for locus presentation.

More specifically, the information processing apparatus refers to the display size information 0902 stored in the display information of instruction content illustrated in FIG. 9. The information processing apparatus decides the initial position of the display of each instruction content in order of the instruction ID stored in the reference table for locus presentation and decides the initial position of the display of each instruction content while securing a region for the display size at constant intervals so that the user can view easily. However, the method for deciding the initial position is not specifically limited and any method that decides the initial position of the display of each instruction content by some algorithm may be used. Lastly, in step S1403, the information processing apparatus renders the display of each instruction content at the calculated initial position before terminating pre-processing.

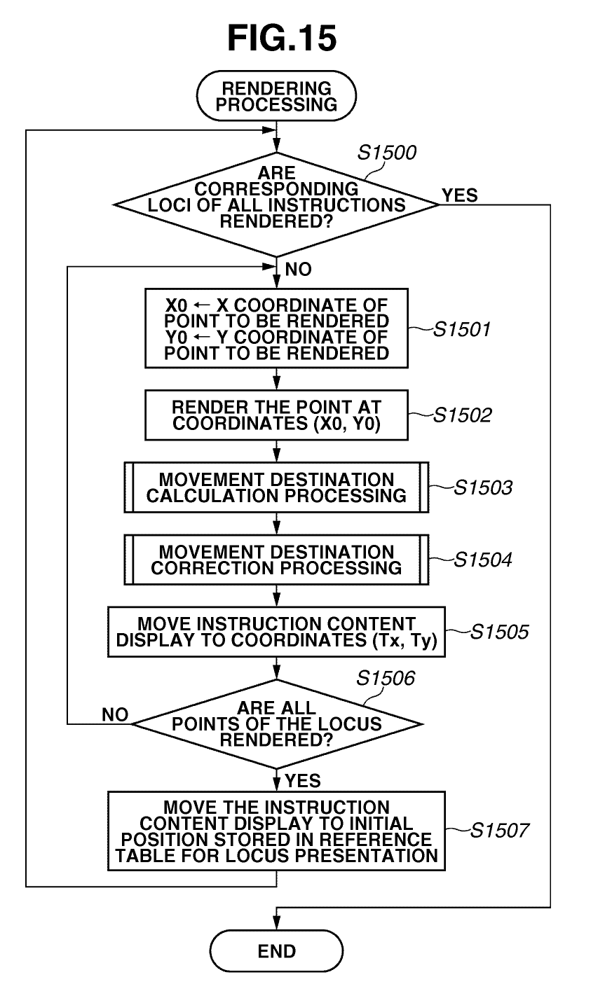

FIG. 15 is a flow chart illustrating details of rendering processing (step S1301) in FIG. 13. First, in step S1500, the information processing apparatus determines whether corresponding instruction loci have been rendered for all processing. In step S1501, if, as a result, it is determined that all loci have not been rendered, the information processing apparatus next refers to the locus information illustrated in FIG. 10 and stores coordinates of a point to be rendered this time in variables X0 and Y0.

Subsequently, in step S1502, the information processing apparatus actually renders the point at the coordinates (X0, Y0). Then, in step S1503, the information processing apparatus moves to processing for calculating the movement destination of the display of instruction content so that the points of the rendered instruction locus can track the display of instruction content. As described above, the display of instruction content is moved in the direction ahead of a point in which the instruction locus will be rendered, to prevent the locus being presented from hiding due to tracking. In step S1504, to prevent the display of instruction content from going out of the screen if the display is moved to the movement destination determined here, the information processing apparatus performs processing for correcting movement destination of the display of instruction content. Processing concerning the movement destination calculation processing (step S1503) and the movement destination correction processing (step S1504) will be described later in detail.

When the above processing is completed, the final movement destination of the display of instruction content is stored in variables Tx and Ty. Then, in step S1505, the information processing apparatus actually moves the display of instruction content to the coordinates (Tx, Ty). Then, in step S1506, the information processing apparatus determines whether all points of the locus have been rendered. In step S1507, if all points of the locus have been rendered, the information processing apparatus brings the display of instruction content that has tracked the locus rendering, back to the initial position stored in the reference table for locus presentation. Then, the information processing apparatus determines whether corresponding loci have been rendered for all processing again and if all rendering has been completed, processing is terminated as is.

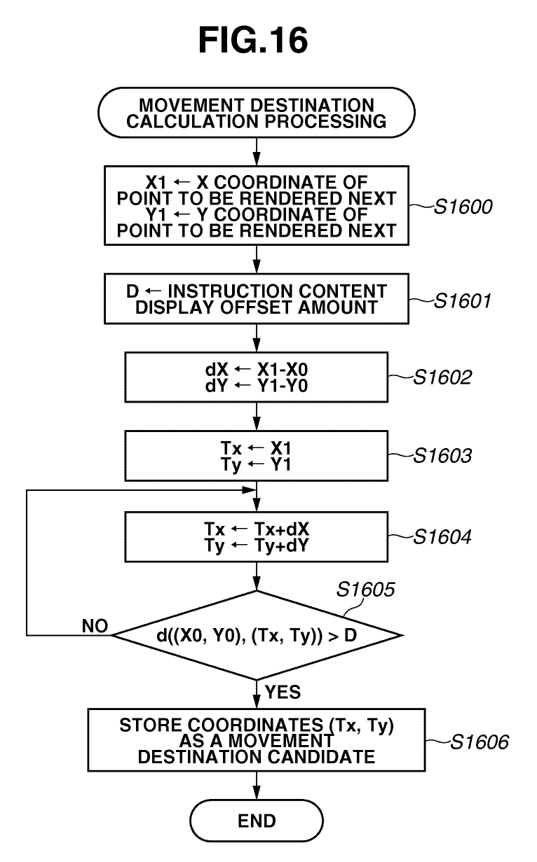

FIG. 16 is a flow chart illustrating details of movement destination calculation processing (step S1503) in FIG. 15. First, instep S1600, the information processing apparatus stores coordinates of a point to be rendered next, in variables X1 and Y1. Similar to the processing described before, the information processing apparatus performs this processing by referring to the locus information illustrated in FIG. 10. This information is used to decide the movement destination of the display of instruction content and the information processing apparatus does not actually render points based on the coordinates. Next, in step S1601, the information processing apparatus stores an offset amount of the pointer 0304 for locus rendering and the display of instruction content in a variable D. This value may be a preset value or a changeable value at runtime on demand and is not specifically limited.

Subsequently, in step S1602, the information processing apparatus stores differences between coordinates of a point to be rendered next and a point rendered immediately before, in variables dX and dY. Next, in step S1603, the information processing apparatus prepares variables Tx and Ty and stores coordinates X1 and Y1 of the point to be rendered next, as initial values thereof. These variables Tx and Ty hold coordinates of the movement destination of the display of instruction content. In step S1604, the information processing apparatus adds the differences dX and dY calculated before to the variables Tx and Ty. Then, in step S1605, the information processing apparatus determines whether coordinates stored in Tx and Ty deviate by an offset amount D from the point rendered immediately before. If coordinates stored in Tx and Ty do not deviate by more than the offset amount, the information processing apparatus returns to the processing of difference addition (step S1604). On the other hand, in step S1606, if coordinates stored in Tx and Ty deviate by more than the offset amount, the information processing apparatus decides the values of the variables Tx and Ty as coordinates of a movement destination candidate and stores the values in the RAM.

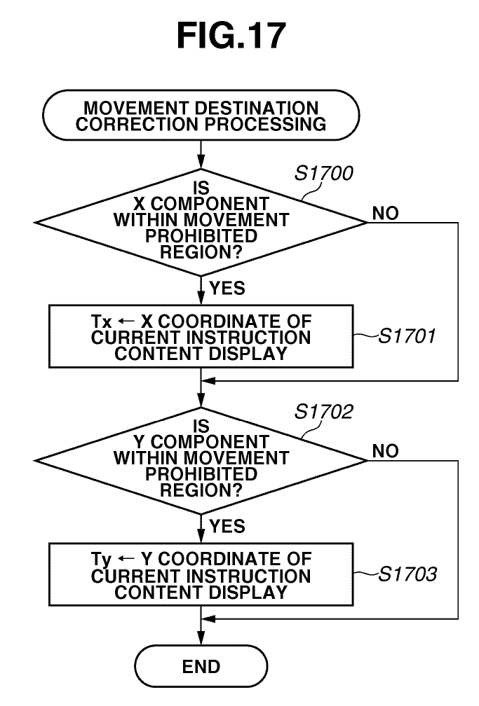

FIG. 17 is a flow chart illustrating details of movement destination correction processing (step S1504) in FIG. 15. In the present exemplary embodiment, the information processing apparatus determines whether coordinates of the movement destination candidate of the display of instruction content determined in FIG. 16 are within a movement prohibited region for each component. If a component is determined to be within the movement prohibited region, the information processing apparatus does not move the display concerning the component.

In step S1700, the information processing apparatus determines whether the X component of the display of instruction content is within a movement prohibited region. The information processing apparatus can make this determination as follows. The information processing calculates a display region of the display of instruction content from the value of the variable Tx and the display size (breadth) of the display of instruction content illustrated in FIG. 9 and examines overlap between the display region and the range of the movement prohibited region. In step S1701, if the display of instruction content will be positioned in the movement prohibited region, the information processing apparatus overwrites the variable Tx with the original position coordinate of the display of instruction content. In steps S1702 and S1703, processing similar to this is also performed on the Y component and the final movement destination of the display of instruction content is decided.

By performing a sequence of processing illustrated above, the information processing apparatus can display the corresponding instruction content by tracking a locus, along with rendering of the locus. Accordingly, the correspondence between a locus and a processing result is explicitly illustrated to the user.

In addition, regarding the present exemplary embodiment, the information processing apparatus may change the display mode of instruction content during tracking movement such as changing the display size of instruction content or changing the display color when the display of the corresponding instruction content moves by tracking in keeping with rendering of a locus. Accordingly, as effects of the exemplary embodiment of the present invention, the correspondence relationship between an instruction locus and instruction content can be communicated to the user more explicitly, but also it becomes easier for the user to check the shape of an instruction locus by, for example, decreasing the display size of instruction content during tracking movement.

Thus, the display of the corresponding instruction content moves by tracking in keeping with rendering of a locus in such a way that when movement of the display of instruction content starts, the information processing apparatus changes the display mode thereof. The information processing apparatus holds information about the display mode before the information is changed, in the display information of instruction content illustrated in FIG. 9. Then, after an instruction locus is displayed, in step S1507 in FIG. 15, when the display of instruction content is brought back to the initial position, the information processing apparatus refers to the information about the display mode before its change and restores also the display mode of instruction content.

In the present exemplary embodiment, an example is described in which the display of instruction content is always moved in the direction ahead of a position in which an instruction locus will be rendered, in order to prevent the instruction locus from hiding due to the tracking display of instruction content. As another method, the information processing apparatus may present the display of instruction content transparently only if the display of instruction content hides an instruction locus being presented. To realize this, the information processing apparatus calculates a range of coordinates covered by the display of instruction content, based on movement destination coordinates of the display of instruction content and information about the display size of the display of instruction content illustrated in FIG. 9. Then, the information processing apparatus determines whether the display of instruction content hides an instruction locus based on whether coordinates of the rendered instruction locus are included in the calculated range.

In the present exemplary embodiment, it is assumed that a plurality of various setting instructions is given. However, when a document is actually printed, the user may give a single setting instruction. If only a single setting instruction is given, because the instruction content corresponding to an instruction locus to be presented is evident to the user, the information processing apparatus may be configured not to explicitly illustrate an instruction locus and instruction content.

In the present exemplary embodiment, an example is describe in which an instruction locus is presented in timing with issuing of a setting instruction by the user. However, an explicit illustration of an instruction locus and instruction content by the information processing apparatus is not necessarily performed in timing with a setting instruction given by the user. Assume, for example, that the user prepares a dedicated screen to give an instruction to list the correspondence relationship between instruction content and instruction loci and the information processing apparatus receives a listing instruction from the user via the screen. The information processing apparatus may acquire a list of instruction loci using the listing instruction as a trigger to display the list and instruction content corresponding to instruction loci contained in the list by explicitly illustrating the correspondence therebetween.

The hardware configuration of an information processing apparatus according to a second exemplary embodiment is the same as that according to the first exemplary embodiment and thus, a description thereof will not be repeated.

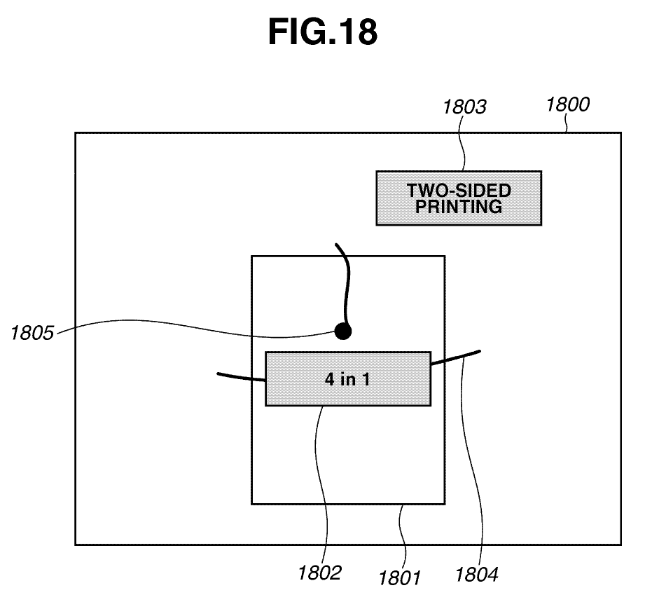

Next, operations of the information processing apparatus according to the second exemplary embodiment configured as described above will be described in detail with reference to FIGS. 18 to 24.

In the first exemplary embodiment, an example is described in which the display of instruction content is always moved in the direction ahead of a position in which a locus will be rendered, so that the locus being presented is not hidden when the information processing apparatus causes the display of instruction content to track a locus in keeping with locus rendering. In the present exemplary embodiment, by contrast, processing will be described in which the information processing apparatus causes the display of instruction content to track presentation of instruction locus in such a way that not only the locus being presented, but also instruction loci rendered in the past are not hidden.

In the first exemplary embodiment, when an instruction locus corresponding to the “4in1” setting is presented, if a display 1802 of instruction content is simply moved in the rendering direction of a locus, as illustrated in FIG. 18, an instruction locus 1804 rendered in the past may be hidden. In such a case, the display of instruction content could become an obstacle to an understanding of the shape of an instruction locus by the user and thus, in the present exemplary embodiment, the position to which the information processing apparatus moves the display of instruction content is decided in the following manner.

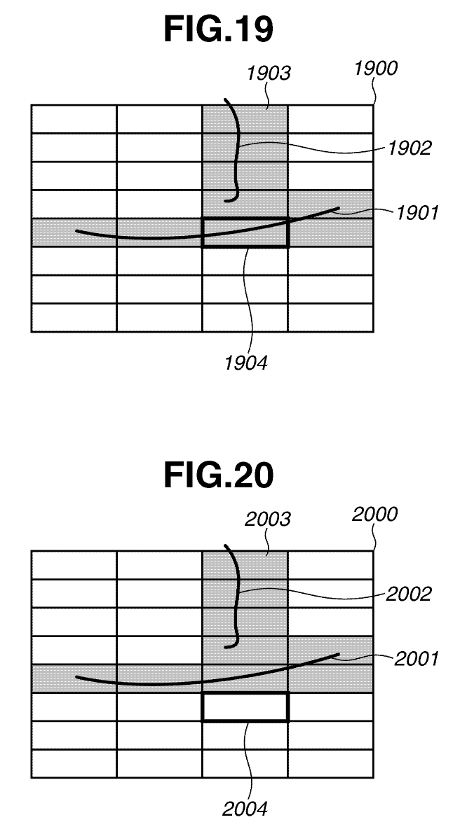

If the information processing apparatus determines that, as a result of moving the display of instruction content, a locus rendered in the past will be hidden, as illustrated in FIG. 19, the information processing apparatus internally divides the whole locus rendering region into a mesh group 1900. Then, the information processing apparatus examines, among such meshes, those meshes through which a locus rendered in the past passes and moves the display of instruction content to a position that avoids such meshes.

In the example according to the present exemplary embodiment, as illustrated in FIG. 19, the information processing apparatus examines meshes through which loci 1901 and 1902 rendered in the past pass. In the figure, the meshes through which the locus rendered in the past pass are colored in a rectangular shape. Each mesh in FIG. 19 is illustrated for convenience of description and is not actually presented to the user via the screen.

While the display of instruction content should originally be moved to the position corresponding to a mesh 1904 in FIG. 19, a locus is already rendered in this mesh and the information processing apparatus does not move the display of instruction content. In the present exemplary embodiment, the information processing apparatus moves the display of instruction content to the position of a mesh nearest to the mesh to which the display of instruction content should originally be moved. No locus passes through the nearest mesh.

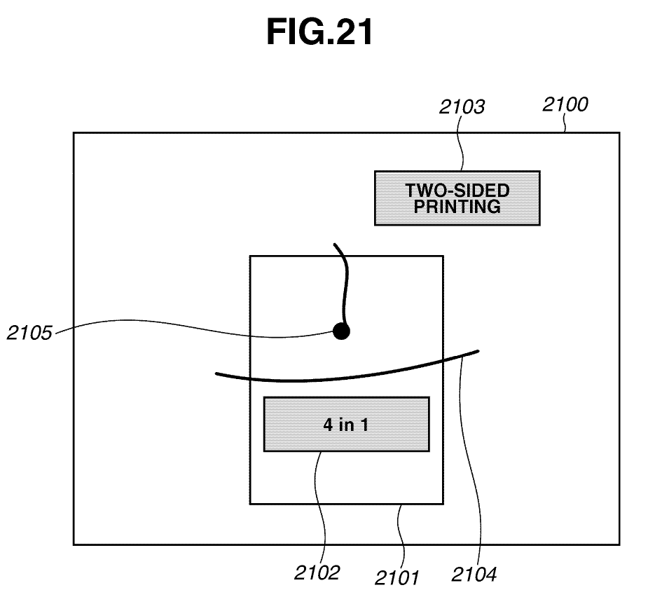

More specifically, in the example according to the present exemplary embodiment, the information processing apparatus moves the display of instruction content to the position corresponding to a mesh 2004 in FIG. 20. As a result, the display of instruction content moves to the position of reference numeral 2102 in FIG. 21. As a result, a situation in which the display of instruction content hides instruction loci rendered in the past can be avoided.

An example of processing to realize the operation of the information processing apparatus described here will be described below in detail using flow charts.

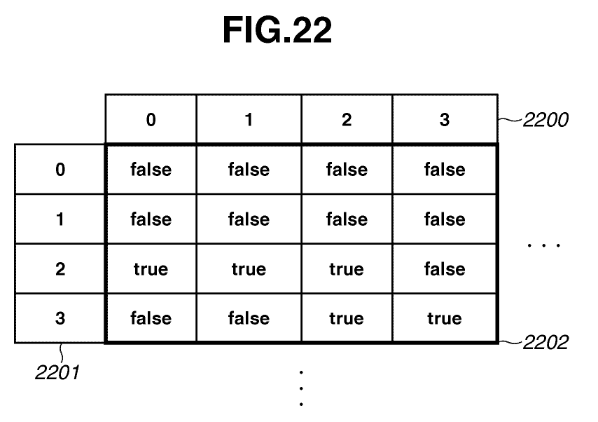

Details of various kinds of information stored in the ROM 0101 and the RAM 0102 are basically the same as those illustrated in FIGS. 9 to 12. However, in the present exemplary embodiment, the information processing apparatus further holds mesh information illustrated in FIG. 22 in the RAM. While the size of individual meshes, that is, the resolution when the locus rendering region is divided is not particularly limited, the movement position of the display of instruction content is more likely to move away from an instruction locus when the resolution is low. On the other hand, overheads needed for processing increase when the resolution is high. Thus, it is necessary for the user or administrator to decide an appropriate resolution based on use of the apparatus. A row 2200 in a table illustrated in FIG. 22 represents the X component of a locus presentation region. A column 2201 represents the Y component of the locus presentation region. A Boolean value is stored in the table corresponding to each mesh. The value “true” indicates that an instruction locus rendered in the past has passed through the mesh at least once and the value “false” indicates that no instruction locus rendered in the past has passed through the mesh.

Details of processing in the present exemplary embodiment are the same as those in the first exemplary embodiment regarding the flow charts about the main processing illustrated in FIG. 13, the pre-processing illustrated in FIG. 14, and the movement destination calculation processing illustrated in FIG. 16 and a description thereof will not be repeated.

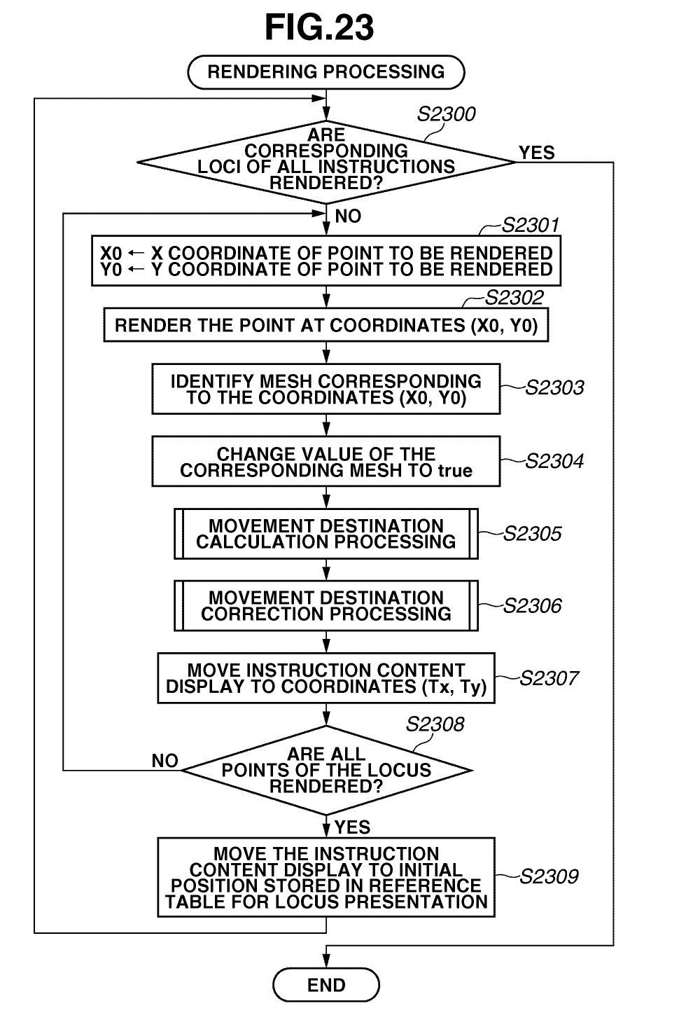

FIG. 23 is a flow chart illustrating details of rendering processing (step S1301) in the present exemplary embodiment. The basic flow is the same as that illustrated in FIG. 13, but in the present exemplary embodiment, the information processing apparatus, after rendering a point at coordinates (X0, Y0) (step S2302), identifies a mesh (corresponding mesh) corresponding to the coordinates (X0, Y0) (step S2303). The information processing apparatus identifies the corresponding mesh by making a division of values stored in the variables X0 and Y0 in accordance with the resolution when the locus rendering region is divided. Then, in step S2304, the information processing apparatus changes to true the value of mesh information about the identified corresponding mesh stored in the RAM 0102. With the above processing, mesh information about meshes through which instruction loci pass is updated each time a locus is rendered.

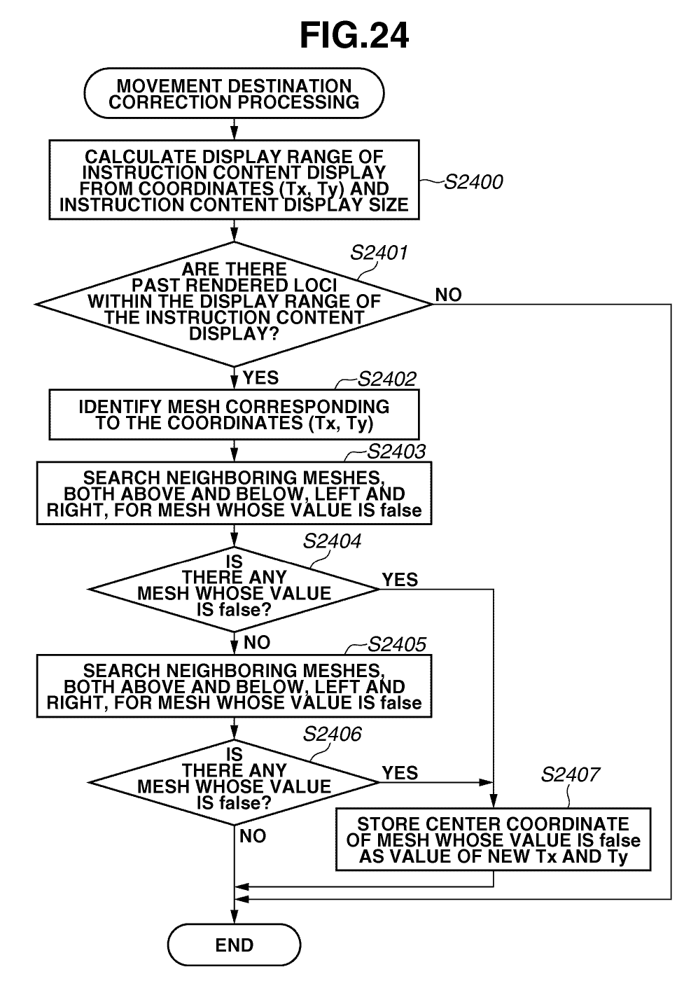

FIG. 24 is a flow chart illustrating details of movement destination correction processing (step S2306) in FIG. 23. Prior to this processing, coordinates (Tx, Ty) of a movement destination candidate of the display of instruction content have been decided in the same manner as in the first exemplary embodiment. First, in step S2400, the information processing apparatus calculates a display region of the display of instruction content when the display of instruction content is moved to the coordinates (Tx, Ty), from the coordinates (Tx, Ty) and the display size information 0902 of the display of instruction content stored as illustrated in FIG. 9. Next, the information processing apparatus determines whether instruction loci rendered in the past are within the display range of the display of instruction content determined here. The information processing apparatus determines whether the instruction loci rendered in the past are within the display range of the display of instruction content based on the locus information illustrated in FIG. 10. If it is determined, as a result, that there is no locus rendered in the past within the display range, the information processing apparatus decides the values of the coordinates (Tx, Ty) as the movement destination of the display of instruction content as they are. On the other hand, in step S2402, if it is determined that there is a locus rendered in the past within the display range, the information processing apparatus subsequently identifies the mesh corresponding to the coordinates (Tx, Ty).

Next, in step S2403, the information processing apparatus searches for a mesh whose value is false, that is, in which no instruction locus is rendered, from among meshes up and down, left and right adjacent to the identified mesh. The information processing apparatus determines whether there is any mesh whose value is false in step S2404 and, if there is a mesh whose value is false, stores its central coordinates as new values of Tx and Ty in step S2407. In step S2405, if, on the other hand, no mesh whose value is false is found, the information processing apparatus searches for a mesh whose value is false, from among meshes upper right, lower right, upper left, and lower left of the identified mesh. If it is determined that a mesh is found in step S2406, the information processing apparatus stores, like the above one, its central coordinates as new values of Tx and Ty in step S2407. If no mesh whose value is false is found here, it is possible to extend the search range to meshes further outside. However, in consideration of overheads in processing the movement of the display of instruction content, the information processing apparatus stops the search in the present exemplary embodiment. In this case, the information processing apparatus uses the values determined in the movement destination calculation processing in step S2305 in FIG. 23 unchanged as the values of Tx and Ty.

By performing a sequence of processing illustrated above in the information processing apparatus, the display of instruction content can track the locus rendering in such a way that not only the locus being presented, but also loci rendered in the past are not hidden.

The hardware configuration of an information processing apparatus according to a third exemplary embodiment is similar to that according to the first exemplary embodiment and thus, a description thereof will not be repeated.

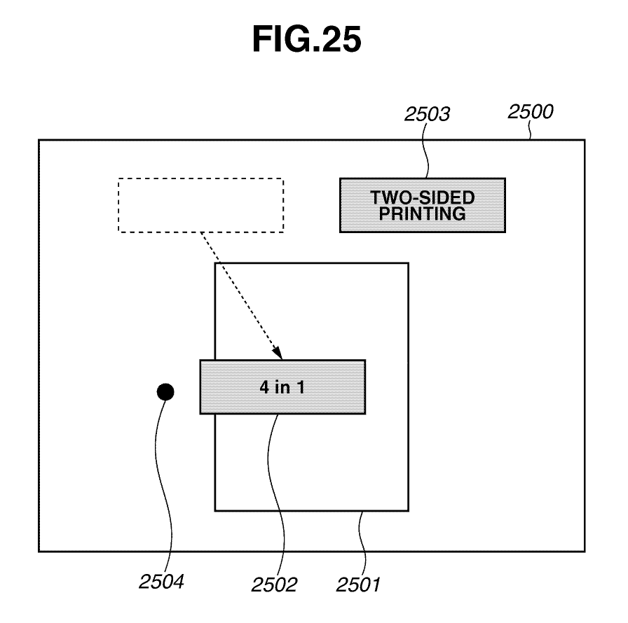

Next, operations of the information processing apparatus according to the third exemplary embodiment configured as described above will be described in detail with reference to FIGS. 25 to 29.

In the first and second exemplary embodiments, the information processing apparatus causes the display of instruction content to track a locus until rendering of an instruction locus is completed. However, depending on the mode of embodiment, it is better to stop tracking when the user completes confirmation of the correspondence relationship so that the user can check locus rendering with concentration. Thus, in the present exemplary embodiment, an example is described in which the information processing apparatus newly sets an initial position movement condition and, if it is determined that the position condition is satisfied, brings the display of instruction content back to its initial position even halfway through presentation of an instruction locus. In the present exemplary embodiment, a movement limiting value is set as an initial position movement condition to the total moving distance of the display of instruction content and when the total moving distance exceeds the movement limiting value, the information processing apparatus brings the display of instruction content to its predetermined position.

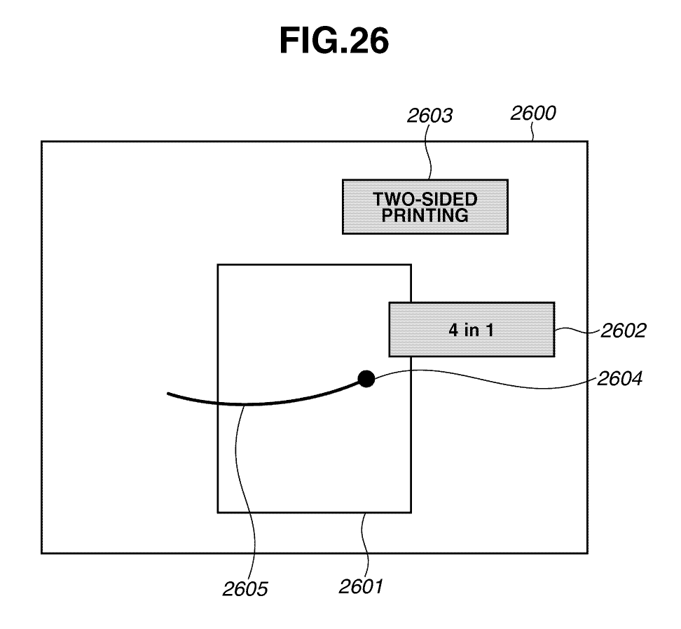

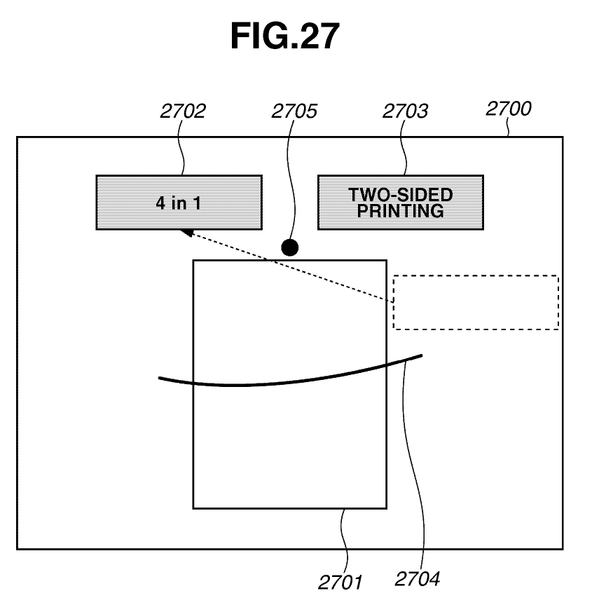

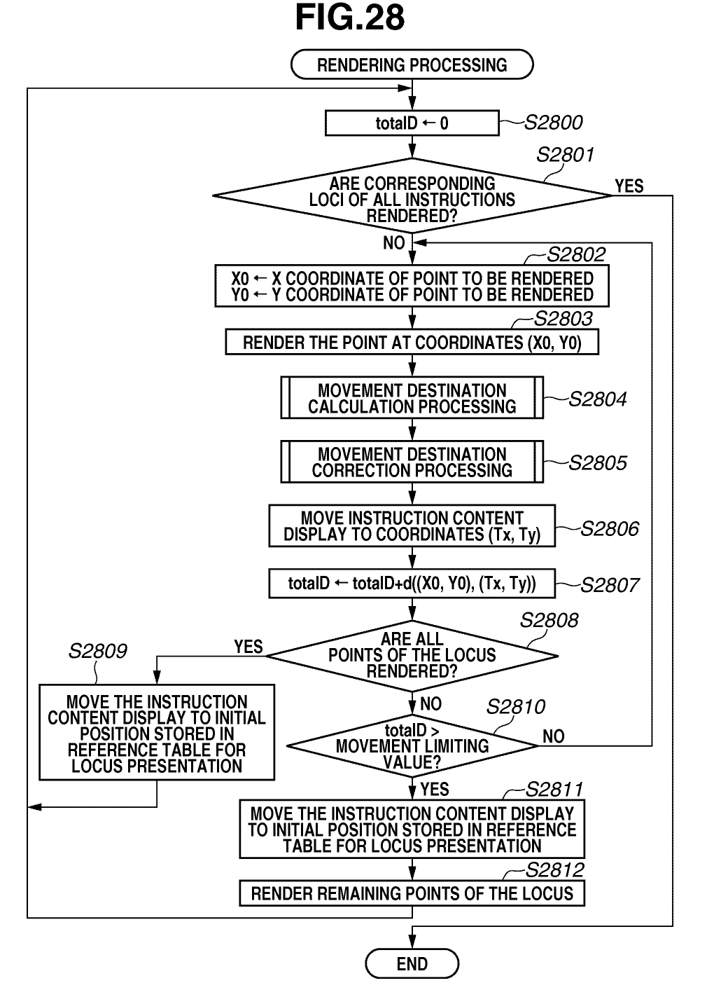

FIG. 25 is a diagram illustrating the screen display shown when, like the first and second exemplary embodiments, the instruction locus corresponding to the “4in1” setting is rendered. Like the above described exemplary embodiments, the information processing apparatus moves a display 2502 of instruction content to within a fixed distance from a pointer 2504 along with the start of rendering of the instruction locus. At this point, the information processing apparatus internally starts to count the total moving distance of the display of instruction content. Next, as illustrated in FIG. 26, like the first and second exemplary embodiments, the information processing apparatus moves a display 2602 of instruction content by tracking the locus rendering. The information processing apparatus continues to count the total moving distance of the display of instruction content. Subsequently, when, as illustrated in FIG. 27, the movement limiting value is exceeded, a display 2702 of instruction content is brought back to its original position. While locus rendering also continues hereafter, it is already shown to the user that the locus being presented is related to the “4in1” setting. Accordingly, understanding this setting, the user can concentrate on checking the locus shape.

An example of processing to realize the operation of the information processing apparatus described here will be described below in detail using flow charts.

Details of various information stored in the ROM 0101 and the RAM 0102 are basically the same as those illustrated in FIGS. 9 to 12 and thus, a description thereof will not be repeated. Flow charts about the main processing illustrated in FIG. 13, the pre-processing illustrated in FIG. 14, the movement destination calculation processing illustrated in FIG. 16, and the movement destination correction processing illustrated in FIG. 17 are also the same as those in the first exemplary embodiment and thus, a description thereof will not be repeated.

FIG. 28 is a flow chart illustrating details of rendering processing (step S1301) in the present exemplary embodiment. The basic flow is the same as that illustrated in FIG. 13, but in the present exemplary embodiment, the information processing apparatus first prepares a variable totalD to hold the total moving distance of the display of instruction content and initializes the variable totalD to 0 in step S2800. In step S2807, after the movement destination of the display of instruction content is decided, the information processing apparatus adds the moving distance of the display of instruction content to this variable totalD.

Then, in step S2809, before rendering the next point, the information processing apparatus determines whether the total moving distance of the display of instruction content exceeds the movement limiting value. At this point, if it is determined that the total moving distance does not exceed the movement limiting value, like the above exemplary embodiments, the information processing apparatus directly proceeds to the processing to render the next point. On the other hand, in step S2810, if it is determined that the total moving distance exceeds the movement limiting value, the information processing apparatus immediately brings the display of instruction content back to its initial position stored in the reference table for locus presentation even halfway through presentation of a locus. Subsequently, in step S2811, the information processing apparatus renders remaining points of the locus without tracking the display of instruction content and moves to rendering of the next instruction locus.

If an initial position movement condition is satisfied by the information processing apparatus performing a sequence of processing illustrated above, the display of instruction content is brought back to its initial position even halfway through presentation of an instruction locus. Thus, the user can concentrate on checking an instruction locus.

While a limiting value is set regarding the total moving distance from the rendering start of an instruction locus as an initial position movement condition. However, for example, an elapsed time after the display of instruction content starts to move may be set as another condition. In this case, instead of the variable totalD holding the total moving distance used in the description of the present exemplary embodiment, the information processing apparatus prepares a variable to hold the elapsed time from the start of locus rendering and, before rendering each point of an instruction locus, checks whether the value of the variable exceeds a threshold. Alternatively, the user's degree of mastery of devices maybe held based on the utilization time. In this case, the limiting value may be increased if the user is unfamiliar with an information processing apparatus. Conversely, if the user is familiar with an information processing apparatus, the limiting value may be decreased.

As another example of the position movement condition, for example, a line-of-sight detection device can be installed in an information processing apparatus. In this case, when the device confirms that the user has checked the instruction locus being rendered and the tracking display of instruction content, the display of instruction content may be brought back to its original position.

In the exemplary embodiments of the present invention described above, as an example, the information processing apparatus moves the display of instruction content by tracking the rendering of an instruction locus to explicitly illustrate the correspondence relationship between an instruction locus and instruction content. In addition, there are example methods which can explicitly illustrate the correspondence relationship between an instruction locus and instruction content as described below.

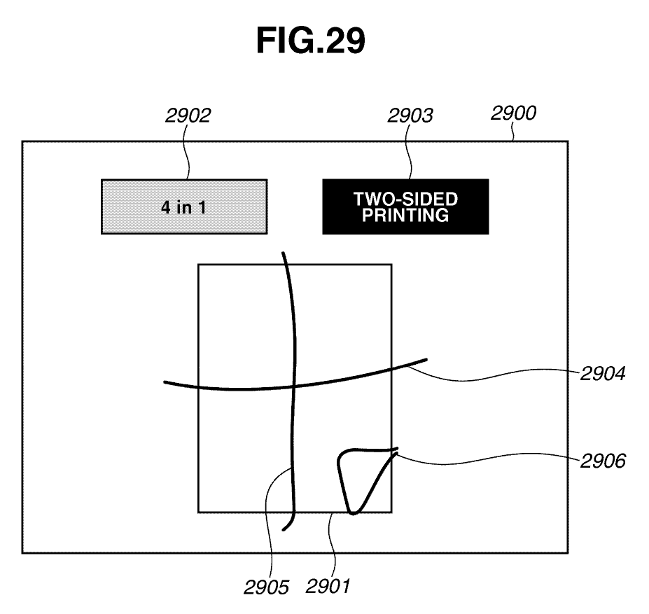

(a) One example is a method by which the information processing apparatus matches the display mode of the corresponding instruction locus and that of the display of instruction content (making the display mode of the corresponding instruction locus and the display of instruction content different from other display modes). The display mode can be any mode that can be checked by the user such as the display color, transparency, thickness of an instruction locus or the display of instruction content. FIG. 29 is a diagram illustrating an example in which the rendering color of an instruction locus and a color in the display of instruction content are matched. While a display 2902 of instruction content representing the “4in1” setting in FIG. 29 is displayed in light gray therein, instruction loci 2904 and 2905 are correspondingly rendered also in light gray. Likewise, the information processing apparatus renders a display 2903 of instruction content representing the “two-sided printing” setting and an instruction locus 2906, using the same black. Thus, the user can confirm the correspondence between an instruction locus and a processing result based on a matched display color. According to this method, a plurality of instruction loci need not necessarily be rendered one after another and a plurality of instruction loci may be presented on the display 0105 from the start. If an instruction locus includes two strokes or more, the information processing apparatus may change brightness of the display color and the like each time the stroke changes in the course of presentation of a locus, so that the user can definitely confirm discontinuity of stroke.

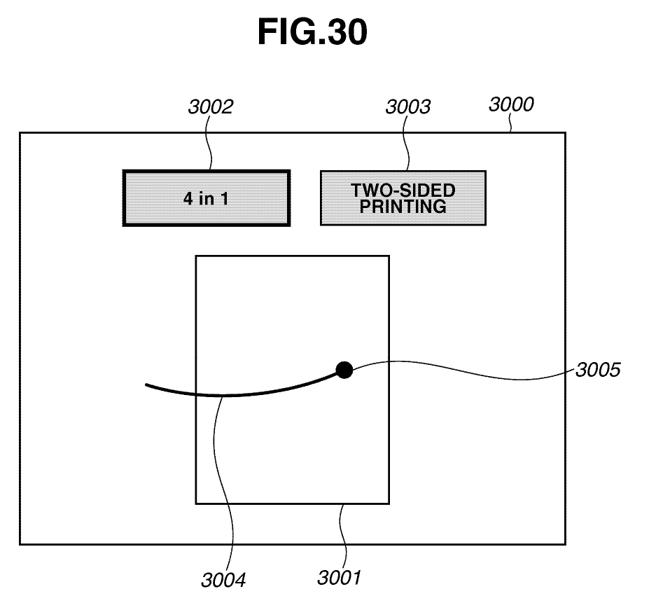

(b) As another example, in timing synchronized with presenting one of an instruction locus and the display of instruction content, the information processing apparatus changes the display mode of the other. For example, FIG. 30 is a diagram illustrating an example in which an outer frame of a corresponding display 3002 of instruction content is thickened in timing with presenting an instruction locus 3004 to make the “4in1” setting. If an instruction locus that makes the “two-sided printing” setting is similarly presented after this, the information processing apparatus thickens the outer frame of a display 3003 of the corresponding instruction content in timing with presenting the locus. By checking these changes in display, the user can confirm the correspondence relationship between an instruction locus being presented and a processing result.

In the present exemplary embodiment, as an example, the information processing apparatus changes the display mode of the display of instruction content in timing with presenting an instruction locus. However, conversely, the thickness of an instruction locus may be changed in timing with presenting the display of instruction content. Moreover, when the display of instruction content or an instruction locus is presented, the information processing apparatus may change the display color or transparency other than the thickness. The type of a display mode to be changed is not specifically limited.

A feature of the present invention is achieved in the following way: A storage medium (recording medium) recording a program code of software to realize a function of the above exemplary embodiments is supplied to a system or an apparatus. Then, a central processing unit (a CPU or micro processing unit (MPU)) of the system or apparatus reads and executes the program code stored in the storage medium. In this case, the program code itself read from the storage medium realizes the function of the above exemplary embodiments and the storage medium recording the program code constitutes the present invention.

By executing the program code read by the central processing unit of the system or apparatus, the operating system (OS) operating in the system or apparatus performs a part or all of actual processing based on instructions of the program code. A case in which the function of the above exemplary embodiments is realized by processing thereof is also included in the present invention.

Further, assume that the program code read from the storage medium is written into a memory contained in a function expansion card inserted into the system or apparatus or a function expansion unit connected to the system. Then, a case in which a CPU contained in the function expansion card or function expansion unit performs a part or all of actual processing based on instructions of the program code and the function of the above exemplary embodiments is realized by the processing is also included in the present invention.

When the present invention is applied to the storage medium, program code corresponding to the flow charts described above will be stored in the storage medium (computer readable storage medium).

According to each of the above exemplary embodiments, instruction content and an instruction locus for issuing the instruction can be presented to a user while explicitly illustrating a correspondence relationship between both.

While the present invention has been described with reference to exemplary embodiments, it is to be understood that the invention is not limited to the discussed exemplary embodiments. The scope of the following claims is to be accorded the broadest interpretation so as to encompass all such modifications and equivalent structures and functions.

This application claims priority from Japanese Patent Application No. 2008-312626 filed Dec. 8, 2008, which is hereby incorporated by reference herein in its entirety.

What is claimed is:

1. An information processing apparatus, comprising:
an instruction identification unit that identifies an instruction based on an operation of the instruction of a user;
an instruction locus identification unit that identifies an instruction locus corresponding to the instruction identified by the instruction identification unit based on association information that associates the instruction and the instruction locus of the instruction; and
a presentation unit that associates and presents content of the instruction identified by the instruction identification unit and the instruction locus identified by the instruction locus identification unit.

2. The information processing apparatus according to claim 1, wherein the instruction identification unit identifies a plurality of instructions based on an operation of the plurality of instructions of the user,
the instruction locus identification unit identifies the instruction locus corresponding to each of the plurality of instructions identified by the instruction identification unit based on the association information, and
the presentation unit displays content of the plurality of instructions identified by the instruction identification unit on a display apparatus, and when one of instruction loci corresponding to each of the plurality of instructions identified by the instruction locus identification unit is displayed on the display apparatus, the presentation unit presents the content of the instruction corresponding to the instruction locus to be displayed, in association, by displaying and moving the content of the instruction to within a fixed distance from the instruction locus.

3. The information processing apparatus according to claim 2, wherein the presentation unit prevents the instruction locus and the content of the instruction from overlapping with each other when the content of the instruction is moved and displayed within the fixed distance from the instruction locus.

4. The information processing apparatus according to claim 2, wherein the presentation unit makes the content of the instruction corresponding to the instruction locus to be displayed transparent if the instruction locus and the content of the instruction overlap with each other when the content of the instruction is moved and displayed within the fixed distance from the instruction locus.

5. The information processing apparatus according to claim 1, wherein the instruction identification unit identifies a plurality of instructions based on an operation of the plurality of instructions of the user,
the instruction locus identification unit identifies the instruction locus corresponding to each of the plurality of instructions identified by the instruction identification unit based on the association information, and
the presentation unit displays the content of the plurality of instructions identified by the instruction identification unit on a display apparatus, and when one of instruction loci corresponding to each of the plurality of instructions identified by the instruction locus identification unit is displayed on the display apparatus, the presentation unit presents the content of the instruction corresponding to the instruction locus to be displayed, in association, by displaying the content of the instruction differently from the content of the other instructions.

6. The information processing apparatus according to claim 2, wherein the presentation unit displays the instruction locus in an order in which the instruction locus is rendered when one of instruction loci corresponding to each of the plurality of instructions is displayed on the display unit.

7. An information processing method of an information processing apparatus, comprising:
identifying an instruction based on an operation of the instruction of a user;
identifying an instruction locus corresponding to the identified instruction based on association information that associates the instruction and the instruction locus corresponding to the instruction; and
associating and presenting content of the identified instruction and the identified instruction locus.

8. The information processing method according to claim 7, wherein the instruction identification identifies a plurality of instructions based on an operation of a plurality of instructions of the user,
the instruction locus identification identifies the instruction locus corresponding to each of the plurality of identified instructions based on the association information, and
the presentation displays the content of the plurality of identified instructions on a display apparatus, and when one of identified instruction loci corresponding to each of the plurality of instructions is displayed on the display apparatus, the content of the instruction corresponding to the instruction locus to be displayed, is presented in association, by displaying and moving the content of the instruction to within a fixed distance from the instruction locus.

9. The information processing method according to claim 8, wherein the presentation prevents the instruction locus and the content of the instruction from overlapping with each other when the content of the instruction is moved and displayed within the fixed distance from the instruction locus.

10. The information processing method according to claim 8, wherein the presentation makes the content of the instruction corresponding to the instruction locus to be displayed transparent if the instruction locus and the content of the instruction overlap with each other when the content of the instruction is moved and displayed within the fixed distance from the instruction locus.

11. The information processing method according to claim 7, wherein the instruction identification identifies a plurality of instructions based on an operation of a plurality of instructions of the user,
the instruction locus identification identifies the instruction locus corresponding to each of the plurality of identified instructions based on the association information, and
the presentation displays the content of the plurality of identified instructions on a display apparatus, and when one of identified instruction loci corresponding to each of the plurality of instructions is displayed on the display apparatus, the content of the instruction corresponding to the instruction locus to be displayed, is presented in association, by displaying the content of the instruction differently from the content of the other instructions.

12. The information processing method according to claim 8, wherein the presentation displays the instruction locus in an order in which the instruction locus is rendered when one of instruction loci corresponding to each of the plurality of instructions is displayed on the display unit.

13. A computer readable storage medium storing computer executable instructions, the instructions causing a computer to perform the functions comprising:
an instruction identification unit that identifies an instruction based on an operation of the instruction of a user;
an instruction locus identification unit that identifies an instruction locus corresponding to the instruction identified by the instruction identification unit based on association information that associates the instruction and the instruction locus of the instruction; and
a presentation unit that associates and presents content of the instruction identified by the instruction identification unit and the instruction locus identified by the instruction locus identification unit.
